(19) United States
(12) Patent Application Publication
(10) Pub. No.: US 2021/0197494 A1
(43) Pub. Date: Jul. 1, 2021

(54) 3D PRINTING SUPPORT STRUCTURE AND DESIGN METHOD

(71) Applicant: LUXCREO (BEIJING) INC., Beijing (CN)

(72) Inventors: Guang ZHU, Beijing (CN); Edward LIN, Beijing (CN); Zhijia LIN, Beijing (CN); Yang LI, Beijing (CN); Zhifeng YAO, Beijing (CN); Siyuan QU, Beijing (CN); Hongyi CHE, Beijing (CN)

(73) Assignee: LUXCREO (BEIJING) INC., Beijing (CN)

(21) Appl. No.: 17/192,916

(22) Filed: Mar. 5, 2021

Related U.S. Application Data
(63) Continuation of application No. PCT/CN2019/105990, filed on Sep. 16, 2019.

(30) Foreign Application Priority Data
Sep. 21, 2018 (CN) 201821549720.3
Aug. 9, 2019 (CN) 201910735447.6
Aug. 9, 2019 (CN) 201910736413.9

(51) Int. Cl. B29C 64/40

(52) U.S. Cl. CPC B29C 64/40; B33Y 40/00

(57) ABSTRACT

The application discloses a hollowed-out printed object and a 3D printing support, a 3D printing support construction method and a 3D printing method of the hollowed-out printed object. At least one end of the 3D printing support of the hollowed-out printed object is connected to the hollowed-out printed object; the support includes a main body and a connecting portion connected to the hollowed-out printed object; a joint between at least part of the connecting portion and the hollowed-out printed object is located inside the hollowed-out printed object.

### CROSS REFERENCE TO RELATED APPLICATIONS

This application is a continuation of International Application No. PCT/CN2019/105990, filed on Sep. 16, 2019, which claims priority to Chinese Patent Application No. 201821549720.3, filed on Sep. 21, 2018, Chinese Patent Application No. 201910735447.6, filed on Aug. 9, 2019, and Chinese Patent Application No. 201910736413.9, filed on Aug. 9, 2019, the contents of each of which are hereby incorporated by reference.

### TECHNICAL FIELD

The present disclosure relates to the field of 3D printing technology, and in particular to structures and design methods of 3D printing support, including methods for constructing hollowed-out printed object and 3D printing support thereof, 3D printed objects and 3D printing support thereof, and 3D printing support, and 3D printing methods for printing hollowed-out printed objects.

### BACKGROUND

A technical principle of 3D printing is to layer a three-dimensional model first, then obtain contour information or image information of each layer, and use powdered metal or resin or other adhesive materials to complete printing of the printed objects layer by layer.

Since 3D printing is to solidify the materials layer by layer and superimpose the materials layer by layer, in principle, an upper structure of a model is generally required to be supported by a lower part of the model. Therefore, if some parts of the printed object are suspended, it is necessary to design support to support these suspended parts of the printed object. In the prior art, after the printing process is completed and the support is separated from the printed object, the support remaining on the surface of the printed object may affect the appearance of the printed object, which may be more likely to affect the normal use of the printed object.

### SUMMARY

In one aspect of the present disclosure, a 3D printing support of a hollowed-out printed object is provided. At least one end of the 3D printing support may be connected to the hollowed-out printed object. The 3D printing support may include a main body and a connecting portion connected to the hollowed-out printed object. A joint between at least part of the connecting portion and the hollowed-out printed object may be located inside the hollowed-out printed object.

In some embodiments, the joint between the at least part of the connecting portion and the hollowed-out printed object is located inside the hollowed-out printed object may include: at least part of the connecting portion extending into a hole or a cavity of the hollowed-out printed object.

In some embodiments, a cross sectional area of one end of the connecting portion connected to the hollowed-out printed object may be less than a cross sectional area of the main body.

In some embodiments, the 3D printing support of claim 1 may include a columnar support, a sheet support, and/or a mesh support.

In some embodiments, the hollowed-out printed object may include at least two sub-printed objects. The at least two sub-printed objects may be the same, and the at least two sub-printed objects may be disposed rotational symmetrically.

In some embodiments, an assembly formed by the 3D printing support and at least part of the hollowed-out printed object may be divided into multiple parallel slices, all slices between each slice of the multiple parallel slices and an initial printed slice may constitute a sub-assembly, and a line connecting a center of gravity of each sub-assembly may be in a first column, the first column may be perpendicular to any slice.

In some embodiments, the hollowed-out printed object may include a hollowed-out sole.

In some embodiments, the hollowed-out sole may be a mesh structure; and at least part of the connecting portion may be connected to columns of the mesh structure of the hollowed-out sole.

In some embodiments, a joint between the at least part of the connecting portion and the hollowed-out sole may be located at a junction of two contour surfaces of the hollowed-out sole.

In another aspect of the present disclosure, a hollowed-out printed object may be provided. The hollowed-out printed object may use the 3D printing support described above.

In some embodiments, the hollowed-out printed object may be a hollowed-out sole.

In another aspect of the present disclosure, a hollowed-out printed object may be provided. The hollowed-out printed object may have connection traces after removing a 3D printing support, and at least part of the connection traces may be located inside the hollowed-out printed object.

In some embodiments, the at least part of the connection traces are located inside the hollowed-out printed object may comprise: at least part of the connection traces may be located on a hole or a cavity of the hollowed-out printed object.

In another aspect of the present disclosure, a method for constructing a 3D printing support of a hollowed-out printed object may be provided. The method may comprise: obtaining a model of a hollowed-out printed object; constructing a support for the model of the hollowed-out printed object. At least one end of the support may be connected to the hollowed-out printed object; the support may include a main body and a connecting portion connected to the hollowed-out printed object; and a joint between at least part of the connecting portion and the hollowed-out printed object may be located inside the hollowed-out printed object.

In another aspect of the present disclosure, a 3D printing method of a hollowed-out printed object may be provided. The method may comprise constructing a support for a model of a hollowed-out printed object according to any construction method of 3D printing support for a hollowed-out printed object described above; and printing the hollowed-out printed object and the support by using a 3D printing device.

In another aspect of the present disclosure, a 3D printing support may be provided. Wherein at least one end of the 3D printing support may be connected to a printed object; an assembly formed by the 3D printing support and at least part of the printed object may be divided into multiple parallel slices, all slices between each slice of the multiple parallel slices and an initial printed slice may constitute a sub-assembly; and a line connecting a center of gravity of each sub-assembly may be in a first column, the first column being perpendicular to any slice.

In some embodiments, the line connecting the center of gravity of each sub-assembly may be perpendicular to any slice.

In some embodiments, the 3D printing support may comprise a main body and a connecting portion connected to the printed object, and a cross sectional area of one end of the connecting portion connected to the printed object may be less than a cross sectional area of the main body.

In some embodiment, the support may comprise a columnar support, a sheet support, and/or a mesh support.

In some embodiments, the sheet support may be provided with one or more through holes extending along a thickness direction of the sheet support.

In some embodiments, a connecting portion of the sheet support and the printed object may have a sawtooth shape.

In some embodiments, the mesh support may include a plurality of unit structures composed of one or more columns; the plurality of unit structures may include at least one of the following structures: a tetrahedron, a cube, a cuboid, an octahedron, a dodecahedron, or an icosahedron.

In some embodiments, both ends of the 3D printing support may be connected to the printed object.

In another aspect of the present disclosure, a 3D printed object may be provided. During being printed, the printed object may use any 3D printing support described above.

In some embodiments, the printed object may include at least two sub-printed objects.

In some embodiments, the at least two sub-printed objects may be the same; and the at least two sub-printed objects may be disposed rotational symmetrically.

In another aspect of the present disclosure, a method for constructing a 3D printing support may be provided. The method may comprise: obtaining a model of a printed object; constructing a support for the model of the printed object, at least one end of the support may be connected to the printed object, an assembly formed by the support and at least part of the printed object may be divided into multiple parallel slices, all slices between each slice of the multiple parallel slices and an initial printed slice may constitute a sub-assembly, and a line connecting a center of gravity of each sub-assembly may be in a first column, the first column may be perpendicular to any slice.

In some embodiments, the support may include a main body and a connecting part connected to the printed object, and a cross sectional area of one end of the connecting portion connected to the printed object may be less than a cross sectional area of the main body.

In some embodiments, the support may include a columnar support, a sheet support, and/or a mesh support.

In still another aspect of the present disclosure, a 3D printing method may be provided. The method may comprise: constructing a support for a model of a printed object according to any method for constructing a 3D printing support described above; using a 3D printing device to print the printed object and the support.

### BRIEF DESCRIPTION OF THE DRAWINGS

The present disclosure is further illustrated in terms of exemplary embodiments. These exemplary embodiments are described in detail with reference to the drawings. These embodiments are not restrictive. In these embodiments, the same number represents the same structure, where:

FIG. 1 is a schematic diagram illustrating a joint between a 3D printing support and a hollowed-out printed object according to some embodiments of the present disclosure;

FIG. 2 is a schematic side diagram illustrating a 3D printing support and a hollowed-out printed object according to some embodiments of the present disclosure;

FIG. 3 is a schematic bottom diagram illustrating a 3D printing support and a hollowed-out printed object according to some embodiments of the present disclosure;

FIG. 4 is a structural diagram illustrating a sub-printed object and a support of a hollowed-out printed object according to some embodiments of the present disclosure;

FIG. 5 is an enlarged schematic diagram illustrating a connection position of a 3D printing support and a hollowed-out printed object according to some embodiments of the present disclosure;

FIG. 6 is a flowchart illustrating a method for constructing a 3D printing support of a hollowed-out printed object according to some embodiments of the present disclosure;

FIG. 7 is a schematic diagram illustrating a connection between a 3D printing support and a 3D printed object according to some embodiments of the present disclosure;

FIG. 8 is a schematic diagram showing a structure of a sheet support of a 3D printing support according to some embodiments of the present disclosure; and

FIG. 9 is a flowchart illustrating a method for constructing a 3D printing support according to some embodiments of the present disclosure.

In the figures, 1 denotes a hollowed-out printed object, 2 denotes a support, 10 denotes a sub-printed object, 21 denotes a sheet support; 22 denotes a mesh support, 201 denotes a main body, 202 denotes a connecting portion, and 221 denotes a unit structure.

### DETAILED DESCRIPTION

In order to make the purpose, technical solutions, and advantages of the present disclosure clearer, the following further describes the present disclosure in detail with reference to the accompanying drawings and embodiments. It should be understood that the specific embodiments described here are only used to explain the application, but not to limit the application.

On the contrary, the present disclosure covers any alternatives, modifications, equivalent methods and solutions defined by the claims in the spirit and scope of the present disclosure. Furthermore, in order to enable the public to have a better understanding of the present disclosure, some specific details are described in detail in the detailed description of the present disclosure below. Those skilled in the art can fully understand the present disclosure without the description of these details.

The embodiments present disclosure mainly relate to a 3D printing support of a hollowed-out printed object. The 3D printing support may be suitable for various scenarios of printing a hollowed-out printed object. For example, the 3D printing support can be applied to 3D printing hollowed-out printed object technologies such as light curing molding, fused deposition rapid prototyping, and a powder bonding molding. In some embodiments, the 3D printing support may be a support in a 3D printing design process, a support in a printing process, or a support after the printing process is completed. The present disclosure also relates to a hollowed-out printed object using a 3D printing support when being printed. The hollowed-out printed object may be a hollowed-out printed object used in various aspects such as medical, industry, life, and art. The present disclosure also relates to a construction method for constructing 3D printing support of a hollowed-out printed object and a method for 3D printing for printing hollowed-out printed objects. Those skilled in the art can use the 3D printing support construction method on software such as Rhino, Solid works, Catia, or UG to realize hollowed-out printed objects. The 3D printing supports are constructed and printed by various 3D printing devices. The present disclosure does not limit the application scenarios of the 3D printing support of the hollowed-out printed object, the hollowed-out printed object, the 3D print support construction method of the hollowed-out printed object, and the 3D printing method.

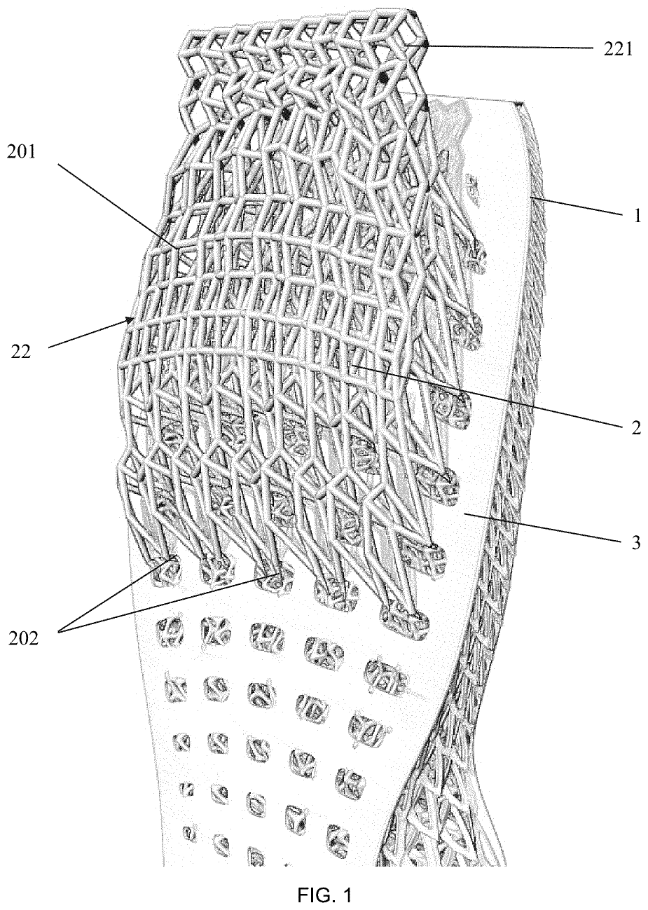

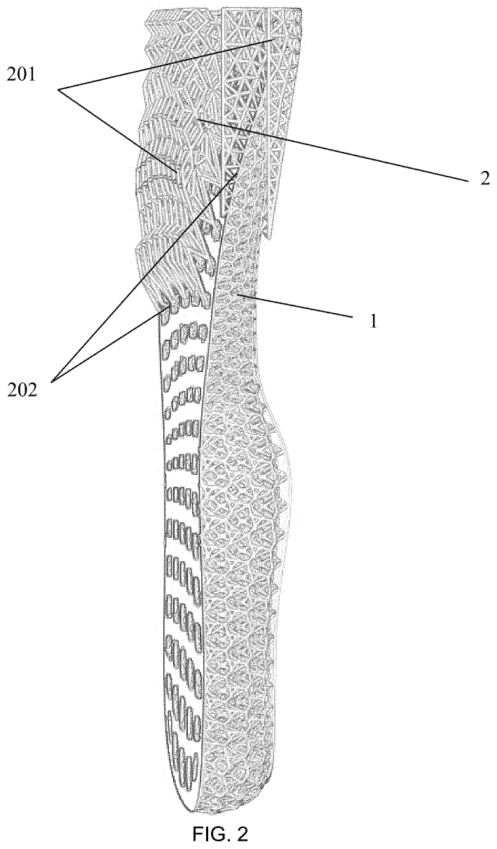

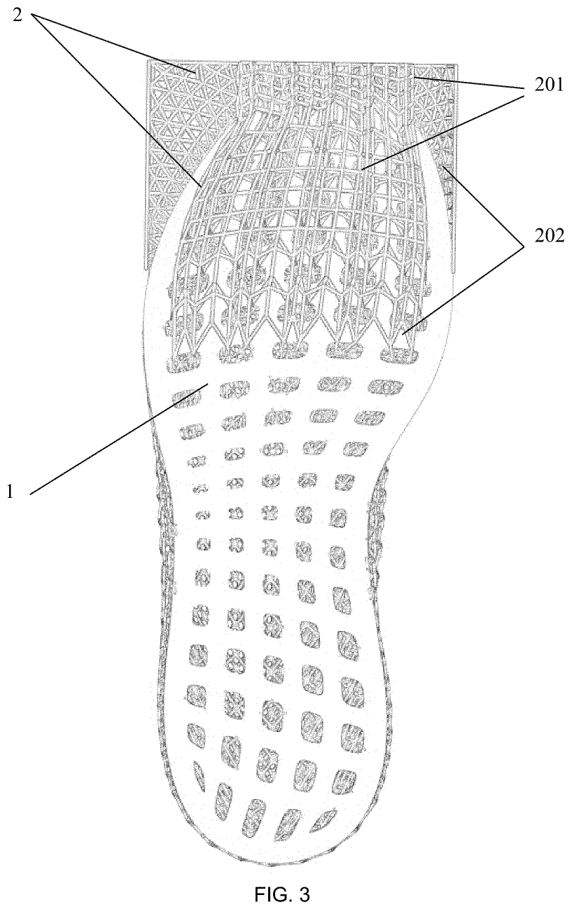

FIG. 1 is a schematic diagram illustrating a joint between a 3D printing support and a hollowed-out printed object according to some embodiments of the disclosure. FIG. 2 is a schematic side diagram illustrating a 3D printing support and a hollowed-out printed object according to some embodiments of the present disclosure. FIG. 3 is a schematic bottom diagram illustrating a 3D printing support and a hollowed-out printed object according to some embodiments of the present disclosure. The 3D printing support of the hollowed-out printed object involved in some embodiment of the present disclosure will be described in detail below in conjunction with FIGS. 1-3. It should be noted that the following examples are only used to explain the application, and do not constitute a limitation to the application.

In some embodiments, as shown in FIG. 1, at least one end of the 3D printing support 2 may be connected to the hollowed-out printed object 1. The 3D printing support 2 may include a main body 201 and a connecting portion 202 connected to the hollowed-out printed object 1. A joint between at least part of the connecting portion 202 and the hollowed-out printed object 1 may be located inside the hollowed-out printed object 1. In some embodiments, the hollowed-out printed object may be a 3D printed product with hollowed structures such as a hole or a cavity therein. The hollowed-out printed object may be all hollowed out, such as a mesh structure printed object, the hollowed-out printed object may also be partially hollowed out, for example, only a certain part of the 3D printed object is a hollow structure. It should be noted that a connection between at least one end of the 3D printing support 2 and the hollowed-out printed object 1 may be that one end of the support 2 is connected to 3D printing forming table, and the other end of the 3D printing support may be connected to the hollowed-out printed object 1. Both ends of the support 2 may be connected to the hollowed-out printed object 1. It should also be noted that a joint between at least part of the connecting portion 202 and the hollowed-out printed object 1 is located inside the hollowed-out printed object 1 can be understood that the joint between all connecting portions 202 and the hollowed-out printed object 1 are all located inside the hollowed-out printed object 1 (shown in FIG. 1); or the joint between a part of the connecting portion 202 and the hollowed-out printed object 1 is located inside the hollowed-out printed object 1, and the joint between the remaining part of the connecting portion 202 and the hollowed-out printed object 1 is located on a surface of the hollowed-out printed object 1. Specifically, the connecting portion 202 is located inside the hollowed-out printed object 1 can be understood as that the connecting portion 202 extends into the hole or cavity of the hollowed-out printed object 1. In some embodiments, the specific structure of the support 2 may be determined according to a shape of the hollowed-out printed object 1. In some embodiments, the construction of the specific structure of the support 2 may be automatically completed by a software algorithm (e.g., Grasshopper), or designed and adjusted in combination with manual work.

The 3D printing support in the following embodiments may also be suitable for supporting other 3D printed objects with a non-hollow structure. In the present disclosure, a hollowed-out printed object is only taken as an example. When the 3D printed object is a non-hollow structure, a joint of the support 2 and the printed object can be located on the surface of the 3D printed object.

In some embodiments, the 3D printing support 2 may include a columnar support, a sheet support 21, a mesh support 22, or the like, or any combination thereof. Those skilled in the art can perform specific settings in an actual operation according to need, and the present disclosure does not limit it. In some embodiments, when the 3D printing support 2 includes a sheet support 21, the sheet support 21 may include one plane or multiple planes that are not parallel to each other, and may also include one or more curved surfaces. A thickness of the sheet support 21 may be 0.1-10 mm.

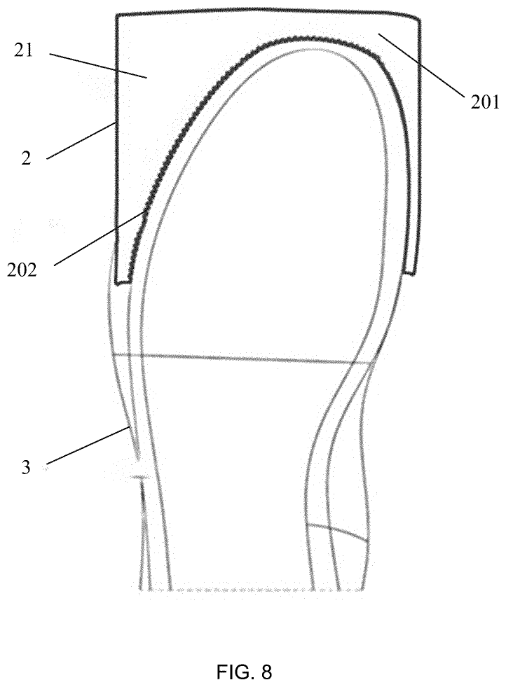

In some embodiments, a cross sectional area of the connecting portion 202 may be equal to that of the main body 201. In some embodiments, the cross sectional area of one end of the connecting portion 202 connected to the hollowed-out printed object 1 may be less than the cross sectional area of the main body 201. Specifically, the connecting portion 202 may be connected between the main body 201 and the hollowed-out printed object 1. The main body 201 may be used to support the hollowed-out printed object 1. The main body 201 may not be connected to the hollowed-out printed object 1, and the connecting portion 202 may connect the main body 201 and the hollowed-out printed object 1 to ensure that the support 2 can be easily removed from the hollowed-out printed object 1 after being printed according to the change of the cross sectional area. This may facilitate the separation of the support 2 from the hollowed-out printed object 1 after the printing is completed, and prevent excessive material of the support 2 from remaining on the hollowed-out printed object 1 and affect normal use of the printed object 1, and also ensure the beauty of the hollowed-out printed object 1. When the main body 201 has different shapes, those skilled in the art can ensure that the cross sectional area of one end of the connecting portion 202 connected to the hollowed-out printed object 1 is less than that of the main body 201 through various design forms. For example, when the support 2 includes a columnar support, the main body portion 201 may include one or more support columns, and the connection portion 202 may include connecting columns respectively connected between the one or more support columns and the hollowed-out printed object 1. A cross sectional area of a connecting column may be less than that of a support column, or the connecting column may be of a pyramid shape, a cone shape, or a truncated cone shape. An end of the connecting column with the less cross sectional area of a pyramid shape, a conical shape, a truncated cone shape, etc. may be connected to the hollowed-out printed object 1 and the end of the connecting column with the greater cross sectional area may be connected with the support column. When the support 2 includes a mesh support 22, the main body 201 may include one or more columns constituting a mesh, and the connecting portion 202 may include a connecting column connected between the columns and the hollowed-out printed object 1. The cross sectional area of the connecting column can be less than that of the column, or the connecting column may be of a pyramid shape, a cone-shape, or a truncated cone shape. An end of the connecting column with the less cross sectional area of a pyramid shape, a cone shape, a frustum shape, etc. may be connected to the hollowed-out printed object 1, and the end of the connecting column with the greater cross sectional area may be connected to the support column. When the support 2 includes a sheet support 21, the main body 201 may include a support sheet. The connecting portion 202 may include a connecting column connected between the support sheet and the hollowed-out printed object 1 with a sawtooth structure or multiple interval spaced connecting columns. As shown in FIG. 8, the end of the sawtooth shaped connecting portion 202 with a less cross sectional area may be connected to the hollowed-out printed object 1, and the end with a greater cross sectional area may be connected to the support sheet. In some embodiments, the connecting portion 202 connecting the sheet support 21 and the hollowed-out printed object 1 may include connecting columns of a pyramid shape, a cone shape, a frustum shape, etc., and an end of the connecting column with the less cross sectional area of a pyramid shape, a cone shape, a truncated cone shape, etc., may be connected to the hollowed-out printed object 1, and the end of the connecting column with the greater cross sectional area may be connected to the support sheet.

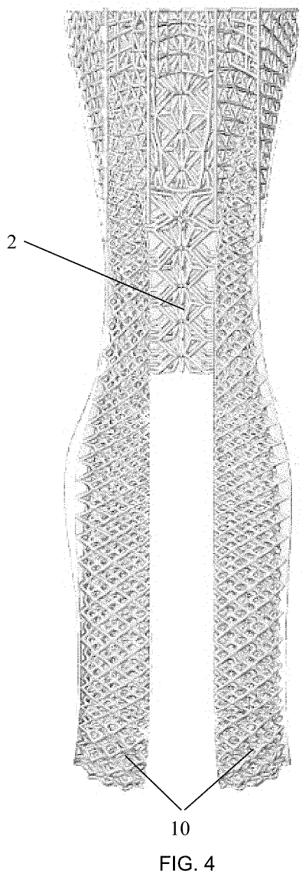

FIG. 4 is a structural diagram illustrating a sub-printed object and a support of a hollowed-out printed object according to some embodiments of the present disclosure. In the embodiment shown in FIG. 4, the hollowed-out printed object 1 may include at least two sub-printed objects 10. When the 3D printed object is a non-hollowed structure, the 3D printed object may also include at least two sub-printed objects. The hollowed-out printed object may be taken as an example for description below. The 3D printing support 2 of any of the above solutions may be connected between two adjacent sub-printed objects 10, and at this time, the support 2 may be connected to a 3D printing forming table, or may not be connected to the 3D printing forming table. During the 3D printing process, at least two sub-printed objects 10 may be printed at the same time, and the support 2 may support and connect each sub-printed object 10, and each sub-printed object 10 can maintain relative stability. Especially for the sub-printed objects 10 that are difficult to be placed separately and stably, the sub-printed objects 10 may be mutually supported by the support 2 to reduce shaking during the printing process. In some embodiments, at least two sub-printed objects 10 may be the same, and the at least two sub-printed objects 10 may be disposed rotational symmetrically. For example, the two sub-printed objects 10 may be disposed in 180° rotational symmetry. As another example, three sub-printed objects 10 may be disposed in 120° rotational symmetry. The disposition of the sub-printed objects may improve the production efficiency of the sub-printed objects 10. In addition, in each slice, the hollowed-out printed object 1 may have a symmetrical structure, which facilitates the design of the structure of the support 2. For example, the support may be designed so that the center of gravity of each slice may be located at the center of rotation. For example, the support in each slice may also be rotationally symmetric with respect to the rotation center of the slice. In some embodiments, the sub-printed object 10 may also include other disposition ways (e.g., an axisymmetric disposition).

In some embodiments, after an assembly formed by the support 2 and at least part of the hollowed-out printed object 1 is divided into multiple parallel slices, all slices between the each slice of multiple parallel slices and an initial printed slice may constitute a sub-assembly, and a line connecting a center of gravity of each sub-assembly may be in a first column perpendicular to any slice. In some embodiments, the first column perpendicular to any slice can be understood as a central axis of the first column being perpendicular to any slice. In some embodiments, the first column may include but not limited to a cylinder, a triangular prism, a quadrangular prism, a hexagonal prism, or the like. In some embodiments, a size of the first column may be set according to specific conditions (e.g., the size of a 3D printed object). For example, when the first column is a cylinder, a diameter of the first column may be set to 0.1-50 mm (e.g., 0.1 mm, 0.5 mm, 1 mm, 5 mm, 10 mm, etc.). In some embodiments, the line connecting the center of gravity of each sub-assembly located in the first column can be understood that the line connecting the center of gravity of each sub-assembly is perpendicular or approximately perpendicular to any slice. In some embodiments, the assembly may be integrally formed by the support 2 and the printed object 1. In some embodiments, the assembly may also be formed by the support 2 and printed object 1 together. For example, the part of the 3D printed object may be a part of the 3D printed object that contains the support after being divided into slices. In some embodiments, an initial printed slice may be a first slice of the 3D printed object 1 printed during being printed.

In some embodiments, to ensure that the line connecting to the center of gravity of each sub-assembly is located in the first column which is perpendicular to any slice, a program may be embedded in the construction software of the support to be invoked or used by default to construct the support. In addition, the division of the assembly into multiple parallel slices can be embodied during the modeling process, the printing process, and/or after the printing is completed. It should also be noted that the divided multiple slices of the assembly may generally be parallel to the 3D printing forming table to facilitate the smooth progress of the 3D printing process. In some embodiments, in order to further prevent the 3D printed objects from shaking during the 3D printing process, the line connecting the center of gravity of each sub-assembly may be made perpendicular to any slice. By disposing the support 2 in the above manner, the hollowed-out printed object 1 can be effectively prevented from shaking during the 3D printing of the hollowed-out printed object 1 and a printing deviation can be reduced. For example, for a bottom-up light-curing 3D printing technology, since light curing starts from a bottom of the resin trough, upon each layer of curing is completed, the molding table may carry the cured print to move up to a height of one layer. The entire printing process may require continuous upward movement of the forming table. The 3D printed objects attached to the forming table may be affected by gravity and uncured liquid (e.g., photosensitive resin, etc.), the upward movement of the forming table after each layer of printing may result in hollowed-out printed object 1 shaking and even causing printing deviation. When the light-cured 3D printing material is an elastomer material, the shaking of the hollowed-out printed object 1 caused by the upward movement of the forming table may be particularly prominent. Elastomer materials may generally have a low Young's modulus and a high failure strain. Large deformation may occur when subjected to force, and can quickly return to approximate original shape and size after the external force is withdrawn. Elastomer materials may include but are not limited to rubber, thermoplastic polyurethane, or the like. The hollowed-out printed object 1 and the support 2 involved in some embodiments of the present disclosure may be printed from elastomer materials.

In some embodiments, as shown in FIGS. 1-4, the hollowed-out printed object 1 may be a hollowed-out sole. By using the hollowed-out sole, the breathability of shoes (especially sports shoes) may be improved. A joint between the at least part of the connecting portion 202 and the hollow shole sole may be located inside the hollowed-out sole, which means that the joint is located in the hollow hole of the hollowed-out sole. Through the above disposition, when the support 2 is removed from the hollowed-out sole, the remaining material of the support 2 may not remain on the outside of the hollowed-out sole, which not only ensures the integrity of the appearance of the hollowed-out sole, but also improves the comfort when using the shoes with the hollowed-out sole.

In some embodiments, the inside of the hollowed-out sole may be a mesh structure, and at least a part of the connecting portion 202 of the support 2 may be connected to the columns of the inner mesh structure of the hollowed-out sole. The inner mesh structure of the hollowed-out sole may not only make the sole light, but also reduce the material used for the hollowed-out sole. When the inside of the hollowed-out sole is set as a mesh structure, the struts of the mesh structure may provide an ideal attachment position for the connecting portion 202 of the support 2 so that the support 2 is easier to separate from the hollowed-out sole. In some embodiments, the hollowed-out sole may be printed with elastomer materials (e.g., rubber, thermoplastic polyurethane, etc.).

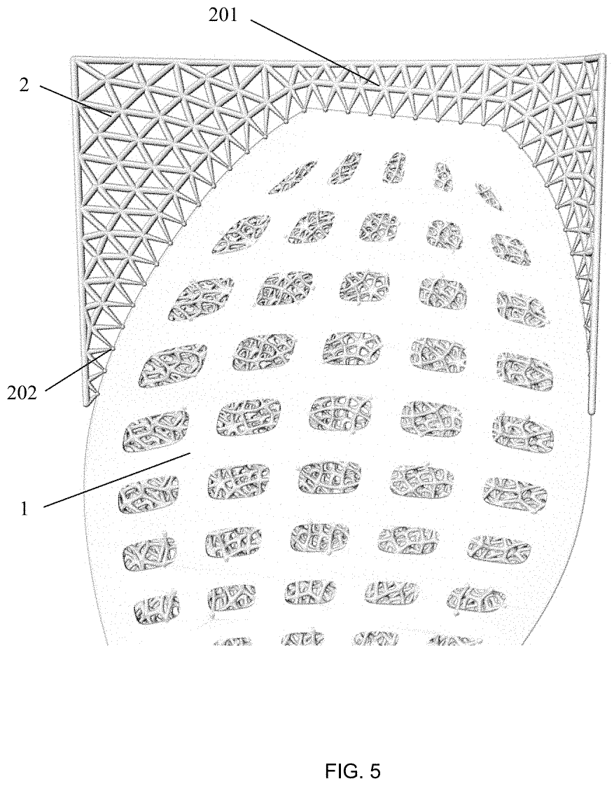

FIG. 5 is an enlarged schematic diagram illustrating a connection position of a 3D printing support and a hollowed-out printed object according to some embodiments of the present disclosure. In the embodiment shown in FIG. 5, the hollowed-out printed object may be a hollowed-out sole, and a joint between the at least part of the connecting portion 202 of the support 2 and the hollowed-out sole may be located at a junction of the two contour surfaces of the hollowed-out sole. In some cases, the connecting portion 202 of the support 2 need to be disposed outside the hollowed-out sole to support the hollowed-out sole. In this case, by positioning the joint at the junction of the two contoured surfaces, the support 2 may be easier to separate from the hollowed-out sole without leaving remaining material of the support 2 on the contoured surface of the hollowed-out printed object 1 to minimize the influence of the remaining material of the support 2 on the appearance of the hollowed-out printed object 1. For example, for a hollowed-out sole, the junction of the two contoured surfaces can be an intersection line between the top surface and the side surface of the sole, or the intersection between the bottom surface and the side surface of the sole. When the hollowed-out printed object 1 includes other 3D printed objects, the joint between the connecting portion 202 and the 3D printed object may also be disposed at the junction of the two contour surfaces of the 3D printed object.

The possible beneficial effects of the 3D printing support of the hollowed-out printed object disclosed in the present disclosure may include but are not limited to: (1) after being separated from the hollowed-out printed object, the remaining material of the support may not remain on the outer surface of the hollowed-out printed object, so as to not affect the appearance and using the function of the hollowed-out printed object 1. (2) It is easy to separate the support from the hollowed-out printed object after being printed. (3) It can prevent the hollowed-out printed object from shaking during the 3D printing process to reduce printing deviation and improve the printing accuracy. It should be noted that different embodiments may have different beneficial effects. In different embodiments, the possible beneficial effects may be any one or a combination of the above, or any other beneficial effects that may be obtained.

Another embodiment of the present disclosure provides a hollowed-out printed object, and the hollowed-out printed object 1 may adopt the 3D printing support 2 of any one of the above technical solutions when being printed. The hollowed-out printed object 1 may use the support 2 of any of the above technical solutions. After the support 2 is separated from the hollowed-out printed object 1, most of remaining material of the support 2 may remain inside the hollowed-out printed object 1 without leaving on an outer surface of the hollowed-out printed object 1, the appearance and the using function of the hollowed-out printed object 1 may not be affected.

In some embodiments, the hollowed-out printed object 1 may be a hollowed-out sole. In other embodiments, the hollowed-out printed object 1 may be a handicraft with a hollow pattern, or an industrial component, or a medical prosthesis with a hollow structure.

Another embodiment provides a hollowed-out printed object. The hollowed-out printed object 1 may have connection traces after removing a 3D printing support, and at least a part of the connection traces may be located inside the hollowed-out printed object 1. Specifically, at least part of the connection traces may be located on a hole or a cavity of the hollowed-out printed object 1. Since the connection traces are located inside the hollowed-out printed object 1, it may not affect the appearance of the hollowed-out printed object 1.

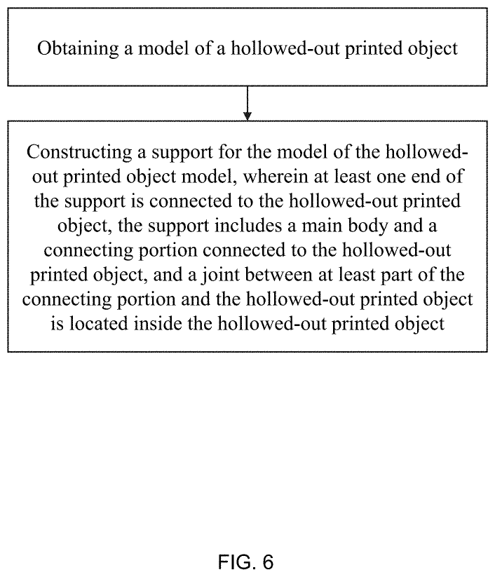

Another embodiment provides a method for constructing a 3D printing support of a hollowed-out printed object. FIG. 6 is a flowchart illustrating a method for constructing a 3D printing support of a hollowed-out printed object according to some embodiments of the present disclosure. As shown in FIG. 6, the method for constructing the 3D printing support 2 may include: obtaining a model of a hollowed-out printed object 1 and constructing a support 2 for the model of the hollowed-out printed object 1. At least one end of the support 2 may be connected to the hollowed-out printed object 1. The support 2 may include a main body 201 and a connecting portion 202 connected to the hollowed-out printed object 1, and a joint between at least a part of the connecting portion 202 and the hollowed-out printed object 1 may be located inside the hollowed-out printed object 1. It should be noted that the connection between at least one end of the support 2 and the hollowed-out printed object 1 may be that one end of the support 2 is connected to the 3D printing forming table, and the other end of the support may be connected to the hollowed-out printed object 1. Both ends of the support 2 may be connected to the hollowed-out printed object 1. The construction of the model of the hollowed-out printed object 1 may be realized by software such as Rhino, Solid works, Catia, or UG. The construction of the support 2 may be determined according to a shape of the hollowed-out printed object 1, and the specific structure construction of the support 2 may be automatically completed by a software algorithm (e.g., Grasshopper), or designed and adjusted in combination with manual work.

In some embodiments, the support 2 may include a main body 201 and a connecting portion 202 connected to the hollowed-out printed object 1. The cross sectional area of one end of the connecting portion 202 connected to the hollowed-out printed object 1 may be less than that of the main body 201. Specifically, the connecting portion 202 may be connected between the main body 201 and the hollowed-out printed object 1, the main body 201 may be used to support the hollowed-out printed object 1, and the connecting portion 202 may connect the main body 201 and the hollowed-out printed object 1. The cross sectional area described above may be variable to ensure that after being printed, the entire support 2 is easily removed from the hollowed-out printed object 1. In some embodiments, the support 2 may include a columnar support, a sheet support, a mesh support, or the like, or any combination thereof. It should be noted that when the 3D printed object is a non-hollowed structure, the construction method of the 3D printing support may also be implemented according to the scheme in the above embodiment. Accordingly, a joint between the 3D printing support and the hollowed-out printed object may be located in the outer surface of the 3D printed object.

In some embodiments, the hollowed-out printed object may include at least two sub-printed objects. The at least two sub-printed objects 10 may be the same, and the at least two sub-printed objects 10 may be disposed rotational symmetrically. Through this disposition, the production efficiency of the sub-printed objects 10 may be improved. In addition, in each slice, the hollowed-out printed objects 1 may be a symmetrical (e.g., center-symmetrical) structure, which facilitates the design of the structure of the support 2. For example, the support may be designed so that the center of gravity of each slice may be located at the center of rotation. For example, the support in each slice may also be rotationally symmetric with respect to the rotation center of the slices.

In some embodiments, after the assembly formed by the support 2 and at least part of the hollowed-out printed object 1 is divided into multiple parallel slices, all slices between each slice and the initial printed slice may constitute a sub-assembly. A line connecting the center of gravity of the sub-assembly may be located in the first column perpendicular to any slice. The process of constructing the support 2 of the model of the hollowed-out printed object 1 may include: constructing a support 2 with at least one end of the support 2 connected to the hollowed-out printed object 1 for the printed object 1; dividing the sub-assembly of the support 2 and the printed object 1 according to a certain layer thickness (e.g., 0.1 mm, 0.15 mm or 0.2 mm, etc.) into multiple parallel slices parallel to the 3D printing forming table; calculating the center of gravity position of each sub-assembly, and adjusting the structure and shape of the support 2 according to the center of gravity position such that the line connecting the center of gravity of each sub-assembly is located in the first column that is perpendicular to any slice. The support 2 of the hollowed-out printed object 1 can be constructed by the above method. The support 2 may not only prevent the hollowed-out printed object 1 from shaking during the process of 3D printing the hollowed-out printed object 1, but also reduce the remaining material of the support 2 left on the surface of the hollowed-out printed object 1 after the hollowed-out printed object 1 is separated from the support.

In some embodiments, the hollowed-out printed object 1 may include a hollowed-out sole. When the support 2 is removed from the hollowed-out sole, the remaining material of the support 2 located inside the hollowed-out sole at the joint may not be left on the outside of the hollowed-out sole, which not only ensures the integrity of the appearance of the hollowed-out sole, but also ensures the comfort when using the shoes with hollowed-out soles.

The possible beneficial effects of the method for constructing the 3D printing support of the hollowed-out printed object disclosed in the present disclosure may include but are not limited to: (1) After being separated from the hollowed-out printed object, the remaining material of the support may not remain on the outer surface of the hollowed-out printed object, so as not to affect the appearance and the using function of the hollowed-out printed object. (2) It is easy to separate the constructed support 2 from the hollowed-out printed object after being printed. (3) The constructed support can prevent the hollowed-out printed object from shaking as much as possible to reduce printing deviation during the 3D printing process. It should be noted that different embodiments may have different beneficial effects. In different embodiments, the possible beneficial effects may be any one or a combination of the above, or any other beneficial effects that may be obtained.

Another embodiment of the present disclosure provides a 3D printing method. The printing method may include: constructing a support 2 for a model of a hollowed-out printed object 1 according to the construction method of 3D printing support of any of the above technical solutions; printing the hollowed-out printed object 1 and the support 2 by using a 3D printing device. The 3D printing device for printing the hollowed-out printed object 1 and the support 2 may be a light curing 3D printer, a fused deposition 3D printer, or a powder bonding 3D printer. The 3D printing method may perform preliminary modeling for the support 2 to construct the support 2 by using the method for constructing the 3D printing support of the hollowed-out printed object. The printed support 2 and the hollowed-out printed object 1 may be easy to separate and can be effective to reduce the material of the support 2 remain on the outer surface of the hollowed-out printed object 1.

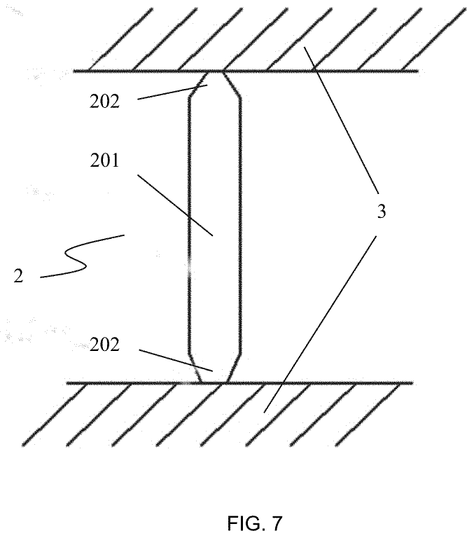

The embodiment of the present disclosure also provides a 3D printing support, at least one end of the 3D printing support 2 may be connected to the 3D printed object 3. After an assembly formed by the support 2 and at least part of the 3D printed object 3 is divided into multiple parallel slices, all slices between each slice and an initial printed slice may constitute sub-assemblies. The line connecting the center of gravity of each sub-assembly may be in a first column perpendicular to any slice. The at least one end of the support 2 connected to the 3D printed object 3 may be that one end of the support 2 is connected to a 3D printing forming table, and the other end of the support is connected to the 3D printed object 3; or both ends of the support 2 are connected to the 3D printed object 3. FIG. 7 is a schematic diagram illustrating a connection between a 3D printing support and a printed object according to some embodiments of the present disclosure. In the embodiment shown in FIG. 7, both ends of the support 2 may be connected to the 3D printed object 3.

In some embodiments, the 3D printing support 2 may include a columnar support, a sheet support 21 and/or a mesh support 22. When the 3D printing support 2 includes a sheet support 21, in order to reduce the material of the support 2, the sheet support 21 may be provided with one or more through holes extending along a thickness direction of the sheet support. The through hole may be a through hole of any shape, such as a circular hole, a square hole, a triangular hole, or other irregularly shaped holes. If the through hole is a circular hole, a diameter of the through hole may be 1-10 mm. In some embodiments, blind holes, buried holes or grooves may also be provided on a sheet support column to reduce the material used for the support 2.

In some embodiments, as shown in FIG. 1, when the 3D printing support 2 includes a mesh support 22, the mesh support 22 may include a plurality of unit structures 221 composed of one or more column. The unit structure 221 may include a tetrahedron, a cube, a cuboid, an octahedron, a dodecahedron, an icosahedron, or the like, or any combination thereof. The one or more column of each unit structure 221 may define a basic geometric shape of the unit structure 221. Those skilled in the art may determine the diameter of the column (for example, set to 2 mm, 3 mm, or 4 mm, etc.) and/or the size of the unit structure according to the structural strength to be designed of the mesh support 22. In some embodiments, the unit structure 221 of the support 2 may also include a plurality of two-dimensional mesh units composed of one or more column, and the two-dimensional mesh units may be triangular, quadrilateral, and/or hexagonal. In some embodiments, those skilled in the art may also provide the mesh support 22 both with a two-dimensional grid and a three-dimensional polyhedral unit member 221. The use of the mesh support 22 may reduce the material used for the support 2 and ensure the support strength of the support 2 to ensure that the support 2 can support the 3D printed object 3 more stably during the printing process. In addition, the mesh support 22 may facilitate changing the center of gravity of each sub-assembly by changing the shape and size of the unit structure 221, thereby ensuring that the line connecting the center of gravity of each sub-assembly is perpendicular or approximately perpendicular to any slice. Especially when applied to support 3D printed object 3 with an irregular shape, the structure of the support 2 may be adjusted by changing the shape and size of the unit structure 221, thereby conveniently adjusting position of the center of gravity of each sub-assembly of the assembly.

The possible beneficial effects of the 3D printing support disclosed in the present disclosure may include but not limited to: (1) It can prevent the 3D printed object from shaking during the 3D printing process to reduce printing deviation and improve printing accuracy. (2) Materials used for the support may be less, which can reduce printing costs. (3) It is easy to separate the support from the 3D printed object after being printed, thereby reducing residue material on the 3D printed object. It should be noted that different embodiments may have different beneficial effects. In different embodiments, the possible beneficial effects may be any one or a combination of the above, or any other beneficial effects that may be obtained.

Another embodiment of the present disclosure provides a method for constructing a 3D printed object, and the 3D printed object 3 may use the support 2 described in any of the above technical solutions when being printed. Through the setting of the support, the 3D printed object may be not easy to shake during the printing process, which can reduce printing deviation as much as possible and improve the printing accuracy.

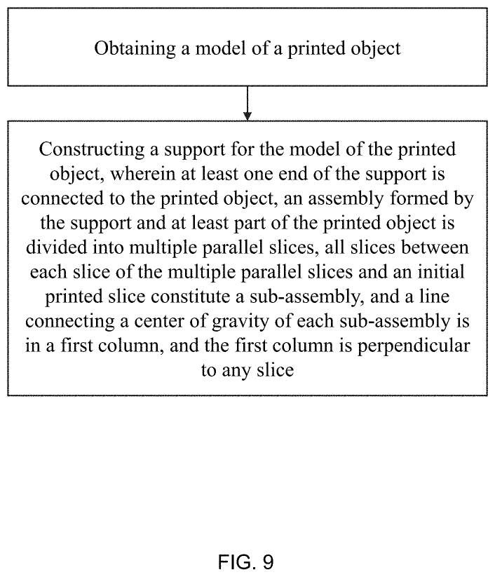

Another embodiment of the present disclosure provides a method for constructing a 3D printing support. FIG. 9 is a flowchart illustrating a method for constructing a 3D printing support according to some embodiments of the disclosure. As shown in FIG. 9, the method may include: obtaining a model of a 3D printed object 3 and constructing a support 2 for the model of the 3D printed object 3. At least one end of the support 2 may be connected to the 3D printed object 3, and after an assembly formed by the support 2 and at least part of the 3D printed object 3 is divided into multiple parallel slices, all slices between each slice and an initial printed slice may constitute a sub-assembly, and a line connecting a center of gravity of each sub-assembly is in a first column perpendicular to any slice. It should be noted that at least one end of the support 2 connected to the 3D printed object 3 may be understood as: one end of the support may be connected to a forming table, and the other end of the support may be connected to the 3D printed object 3, or both ends of the support may be connected to the 3D printed object 3.

The possible beneficial effects of the method for constructing the 3D printing support disclosed in the present disclosure may include but not limited to: (1) Suitable support may be constructed to prevent the 3D printed objects from shaking as much as possible during the 3D printing process and reduce printing deviation. (2) The constructed support can reduce materials and printing costs. (3) It is easy to separate the constructed support 2 from the 3D printed object after being printed, thereby reducing the remaining material of the support on the 3D printed object. It should be noted that different embodiments may have different beneficial effects. In different embodiments, the possible beneficial effects may be any one or a combination of the above, or any other beneficial effects that may be obtained.

Another embodiment of the present disclosure provides a 3D printing method, the printing method may include: constructing a support 2 for a model of a 3D printed object 3 according to the method for constructing a 3D printing support of any of the above technical solutions; using a 3D printing device to print the 3D printed object 3 and the support 2. The 3D printing device that prints the 3D printed object 3 and the support 2 may be a light curing 3D printer. By using the above-mentioned method for constructing the 3D printing support to perform preliminary modeling for 3D printing, the support 2 and 3D printed object 3 may be constructed, which can reduce shaking of the 3D printed object 3 when the 3D printing device prints the support 2 and the 3D printed object 3 to make the 3D printed object 3 more accurate during the 3D printing process.

The above are only preferred embodiments of the present disclosure, and are not intended to limit the present disclosure. Any modification, equivalent replacement and improvement made within the spirit and principle of the present disclosure shall be included in the protection scope of the present disclosure.

1. A 3D printing support of a hollowed-out printed object, wherein
at least one end of the 3D printing support is connected to the hollowed-out printed object;
the 3D printing support includes a main body and a connecting portion connected to the hollowed-out printed object; and
a joint between at least part of the connecting portion and the hollowed-out printed object is located inside the hollowed-out printed object.

2. The 3D printing support of claim 1, wherein the joint between the at least part of the connecting portion and the hollowed-out printed object is located inside the hollowed-out printed object includes:
at least part of the connecting portion extending into a hole or a cavity of the hollowed-out printed object.

3. The 3D printing support of claim 1, wherein a cross sectional area of one end of the connecting portion connected to the hollowed-out printed object is less than a cross sectional area of the main body.

4. The 3D printing support of claim 1, comprising a columnar support, a sheet support, and/or a mesh support.

5. The 3D printing support of claim 1, wherein the hollowed-out printed object includes at least two sub-printed objects, the at least two sub-printed objects are the same, and the at least two sub-printed objects are disposed rotational symmetrically.

6. The 3D printing support of claim 1, wherein
an assembly formed by the 3D printing support and at least part of the hollowed-out printed object is divided into multiple parallel slices,
all slices between each slice of the multiple parallel slices and an initial printed slice constitute a sub-assembly, and
a line connecting a center of gravity of each sub-assembly is in a first column, the first column being perpendicular to any slice.

7. The 3D printing support of claim 1, wherein the hollowed-out printed object includes a hollowed-out sole.

8. The 3D printing support of claim 7, wherein the hollowed-out sole is a mesh structure; and
at least part of the connecting portion is connected to columns of the mesh structure of the hollowed-out sole.

9. The 3D printing support of claim 8, wherein a joint between the at least part of the connecting portion and the hollowed-out sole is located at a junction of two contour surfaces of the hollowed-out sole.

10-11. (canceled)

12. A hollowed-out printed object, wherein the hollowed-out printed object has connection traces after removing a 3D printing support, and at least part of the connection traces are located inside the hollowed-out printed object.

13. The hollowed-out printed object of claim 12, wherein the at least part of the connection traces are located inside the hollowed-out printed object comprises:
at least part of the connection traces is located on a hole or a cavity of the hollowed-out printed object.

14. A method for constructing a 3D printing support of a hollowed-out printed object, comprising:
obtaining a model of a hollowed-out printed object;
constructing a support for the model of the hollowed-out printed object, at least one end of the support being connected to the hollowed-out printed object, the support including a main body and a connecting portion connected to the hollowed-out printed object, and a joint between at least part of the connecting portion and the hollowed-out printed object being located inside the hollowed-out printed object.

15. The method of claim 14, wherein the connection between the at least part of the connecting portion and the hollowed-out printed object is located inside the hollowed-out printed object includes:
at least part of the connecting portion extending into a hole or a cavity of the hollowed-out printed object.

16. The method of claim 14, wherein a cross sectional area of one end of the connecting portion connected to the hollowed-out printed object is less than a cross sectional area of the main body.

17. The method of claim 14, wherein the support comprises a columnar support, a sheet support, and/or a mesh support.

18. The method of claim 14, wherein the hollowed-out printed object includes at least two sub-printed objects, the at least two sub-printed objects are the same, and the at least two sub-printed objects are disposed rotational symmetrically.

19. The method of claim 14, wherein
an assembly formed by the support and at least part of the hollowed-out printed object is divided into multiple parallel slices,
all slices between each slice of the multiple parallel slices and an initial printed slice constitute a sub-assembly, and
a line connecting a center of gravity of each sub-assembly is in a first column, the first column being perpendicular to any slice.

20. The method of claim 14, wherein the hollowed-out printed object includes a hollowed-out sole.

21-36. (canceled)
